(19) United States
(12) Patent Application Publication
(10) Pub. No.: US 2023/0322473 A1
(43) Pub. Date: Oct. 12, 2023

(54) Method for protecting plant products during transport, and corresponding treatment device

(71) Applicant: XEDA INTERNATIONAL S.A., Saint Andiol (FR)

(72) Inventor: Alberto Sardo, Chateaurenard (FR)

(21) Appl. No.: 18/024,183

(22) PCT Filed: Sep. 1, 2021
(86) PCT No.: PCT/EP2021/074155

§ 371 Date: Mar. 1, 2023

(30) Foreign Application Priority Data
Sep. 2, 2020 (FR) FR2008920

(51) Int. Cl. B65D 85/50; A23B 7/154

(52) U.S. Cl. CPC B65D 85/50; A23B 7/154

(57) ABSTRACT

The protection process comprises transporting vegetable products (1) in an enclosure (3), a phyto-protective treatment being applied simultaneously by placing a quantity of a porous mineral or vegetable material (5) inside said enclosure (3), in which a liquid containing an essential oil or a constituent of an essential oil is absorbed;
the porous mineral or vegetable material (5) having a liquid absorption capacity of between 5% and 30% by weight at 20° C.;
the evaporation rate of the liquid absorbed in the porous mineral or vegetable material (5) being between 10 and 200 g per day and per kg of absorbed liquid at a temperature suitable for the preservation of the vegetable products and at atmospheric pressure;
the porous mineral or vegetable material (5) being arranged inside at least one openwork container (7) allowing an internal atmosphere of the enclosure (3) to circulate through the openwork container (7) in contact with the porous mineral or vegetable material (5).

### The present invention relates in general to the transportation of vegetable products over long distances, within large volume enclosures.

Vegetable products such as potatoes can be transported between production areas and consumption areas over long distances. This transportation takes between 20 and 30 days, for example, and it is necessary to apply a phyto-protective treatment for a period long enough to guarantee the quality of the products delivered to the consumers.

In the case of potatoes, it is known to use a solid synthetic anti-sprouting product, chlorpropham, to protect the potatoes during transportation.

Due to regulatory changes, these solid synthetic anti-sprouting products are now prohibited.

There is therefore a need for a process that allows vegetable products to be transported over long distances, while ensuring phyto-sanitary treatment over a long period of time, guaranteeing the quality of the products upon arrival.

In this context, the invention aims to propose a process of vegetable products protection during transportation, the method comprising:
placing a mass of vegetable products of between 5 and 50 tons in a large volume enclosure;
transporting said vegetable products in said enclosure for a period of between one week and two months, a phyto-protective treatment being applied to the vegetable products during at least part of said period;
the treatment being applied by placing in said enclosure a quantity of a porous mineral or vegetable material in which a liquid containing at least one treatment product is absorbed, the treatment product being an essential oil or a constituent of an essential oil;
the porous mineral or vegetable material having a liquid absorption capacity at 20° C. of between 5% and 30% by weight;
the daily evaporation rate of the liquid absorbed in the porous mineral or vegetable material being between 10 and 200 g per kg of absorbed liquid, at a temperature suitable for the preservation of the vegetable products and at atmospheric pressure;
the porous mineral or vegetable material being arranged inside at least one openwork container allowing an internal atmosphere of the enclosure to circulate through the openwork container in contact with the porous mineral or vegetable material.

Thus, the method is aimed at transporting large quantities of plant products, between 5 and 30 tons per transport container. It is not intended for the transporting vegetable products in small packages, nor for storing of vegetable products in very large volume storage enclosures, such as silos.

It is also aimed at a phyto-protective treatment applied for a medium period of time, between one week and two months, and not a very long term phyto-protective treatment (up to one year) of the type applied to certain vegetable products stored in silos or cold-storage rooms.

The phyto-protective treatment is particularly adapted to the conditions stated above, because of the choice of the mineral or vegetable porous material used.

This porous mineral or vegetable material must have a sufficient absorption capacity for the liquid containing the essential oil. If this absorption capacity is insufficient, a very large volume of porous mineral or vegetable material must be loaded into the transport chamber. The porous mineral or vegetable material then occupies a significant space within the transport chamber, to the detriment of the vegetable products. The amount of vegetable products that can be transported is reduced. A large volume of porous mineral or vegetable material is also cumbersome to handle and costly. In addition, the porous mineral or vegetable material increases the total mass carried in the enclosure.

The evaporation rate of the liquid absorbed in the porous mineral or vegetable material must be fast enough to make the treatment effective. It must allow the essential oil vapor concentration in the atmosphere of the enclosure to be reached almost immediately. If this evaporation capacity is too low, it becomes necessary to carry an excessively large quantity of porous mineral or vegetable material in the transport chamber, with the disadvantages in terms of handling, cost, volume occupied and mass already mentioned above.

The evaporation rate of the absorbed liquid must not be excessively high either, so that the phytosanitary treatment can last the whole transport period.

In addition, in order to ensure effective diffusion of the product, there must be no obstacle preventing the circulation of the internal atmosphere of the enclosure in contact with the porous mineral or vegetable material. For that, it is necessary for the container to be openwork, to facilitate the circulation of the essential oil vapor and of the internal atmosphere of the enclosure.

Due to the appropriate choice of the means for diffusing the treatment product, the process of the invention ensures adequate preservation of the vegetable products within a large volume enclosure, throughout the duration of the transportation.

The process may also have one or more of the following features, considered individually or in any technically possible combination:
the enclosure is a container or a truck;
the vegetable products are selected from the following list: pomaceous plants such as apples, stone fruits, tropical fruits such as bananas, red fruits such as cherries and strawberries, forest fruits such as blueberries, potatoes, onions, garlic, sweet potatoes, citrus fruits;
the or each treatment product is selected from the following list:
the essential oil: mint oil, clove oil, rose oil, thyme oil, oregano oil; eucalyptus oil, cinnamon oil, peppermint oil.
constituent of an essential oil: L-carvone, eugenol, geraniol, thymol, carvacrol, cinnamaldehyde, eucalyptol, menthol, menthone, limonene, citronellol;
the porous mineral or vegetable material is selected from the following list: pumice, pozzolan, clay balls, cellulose, pine bark;
the or each openwork container has a void ratio greater than 20% per area unit;
the or each openwork container is selected from the following list: jute bag, mesh bag, net, box;
the or each openwork container contains between 1 and 20 kg of porous mineral or vegetable material;
the porous mineral or vegetable material is divided into blocks sized between 0.5 and 10 cm;
the process comprises a step of loading the porous mineral or vegetable material with said liquid, the loading step comprising the following sub-steps:
   drying of the porous mineral or vegetable material;
   impregnation of the liquid in the porous mineral or vegetable material.

According to a second aspect, the invention relates to a device for treating vegetable products during long-term transport in a large-volume enclosure, comprising:
between 1 and 20 kg of a porous mineral or vegetable material;
between 0.1 kg and 6 kg of a liquid absorbed in the porous mineral or vegetable material, the liquid containing at least one treatment product, the treatment product being an essential oil or a constituent of an essential oil;
the porous mineral or vegetable material having a liquid absorption capacity of between 5% and 30% by weight at 20° C., the evaporation rate of the liquid absorbed in the porous mineral or vegetable material being between 10 and 200 g per day per kg of absorbed liquid at a temperature suitable for preserving vegetable products and at atmospheric pressure;
an openwork container inside which the porous mineral or vegetable material is arranged, the openwork container allowing an atmosphere to circulate through the openwork container in contact with the porous mineral or vegetable material;
an overpack that is impermeable to said liquid and to the vapors of the treatment product, in which the openwork container containing the porous mineral or vegetable material is placed.

The use of a liquid and vapor tight overpack of the or each essential oil allows for adequate preservation of the liquid laden mineral or vegetable material before it is loaded into the transport container. At the time of loading the porous mineral or vegetable material into the transport enclosure, the airtight overpack is removed, and the openwork container loaded with the porous mineral or vegetable material is placed in the transport enclosure. Liquid vapors can then diffuse freely through the openwork container, allowing treatment of the plant material placed in the transport chamber.

Other advantageous features of the invention will be apparent from the detailed description below, given by way of indication and not in any way limiting, with reference to the appended figures, among which:

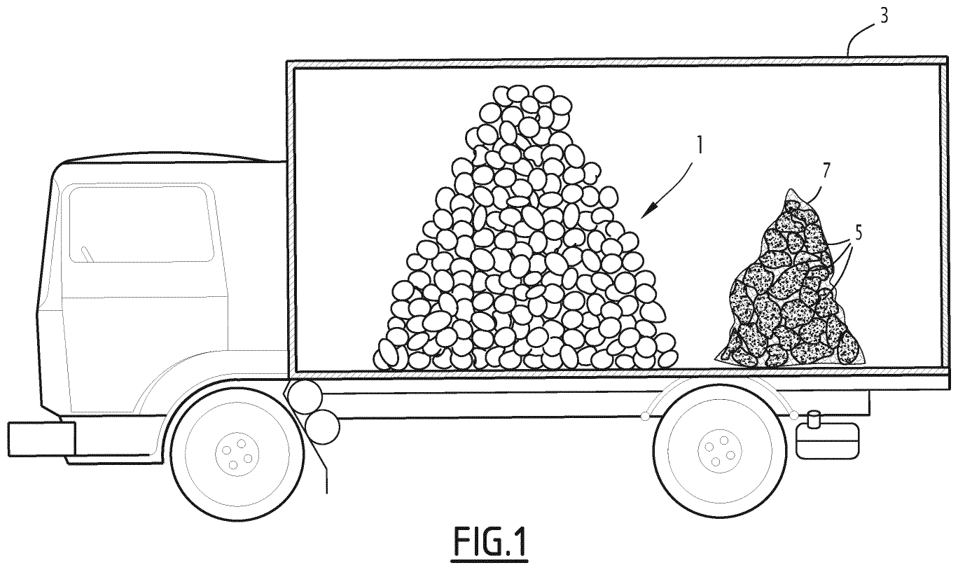

FIG. 1 is a schematic representation of a transport enclosure used in the process of the invention;

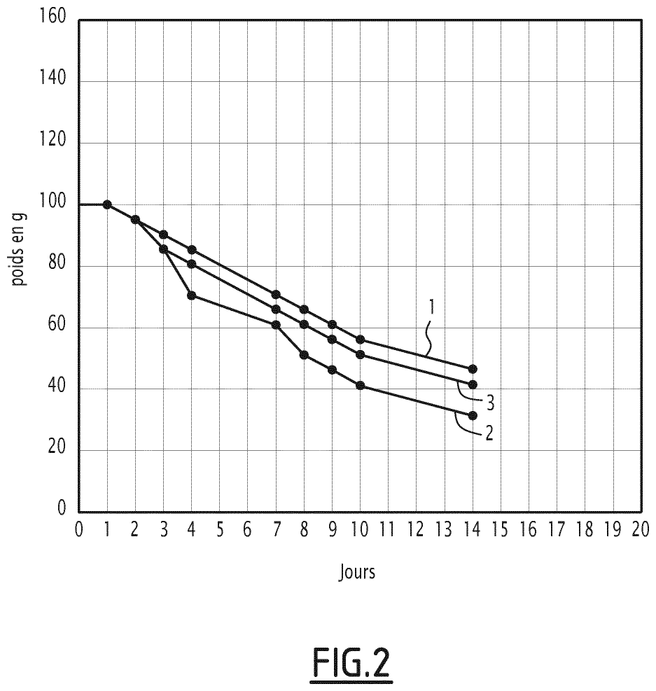

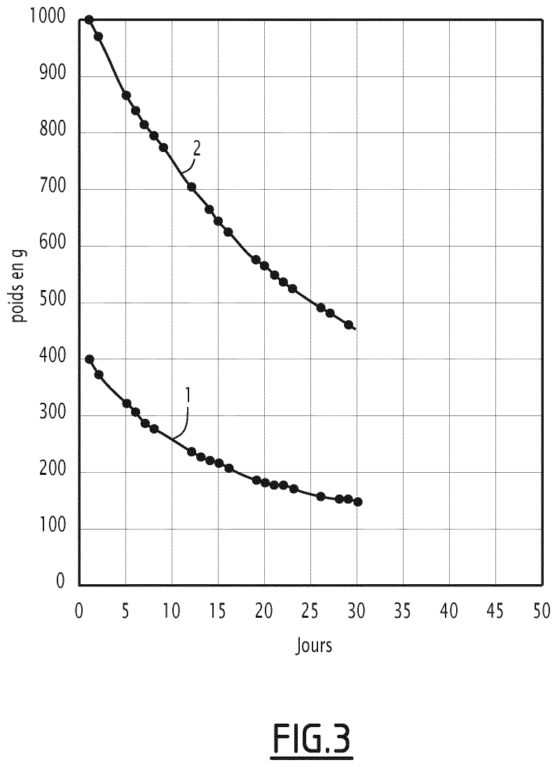

FIGS. 2 and 3 are curves showing the results of evaporation tests, for different porous materials;

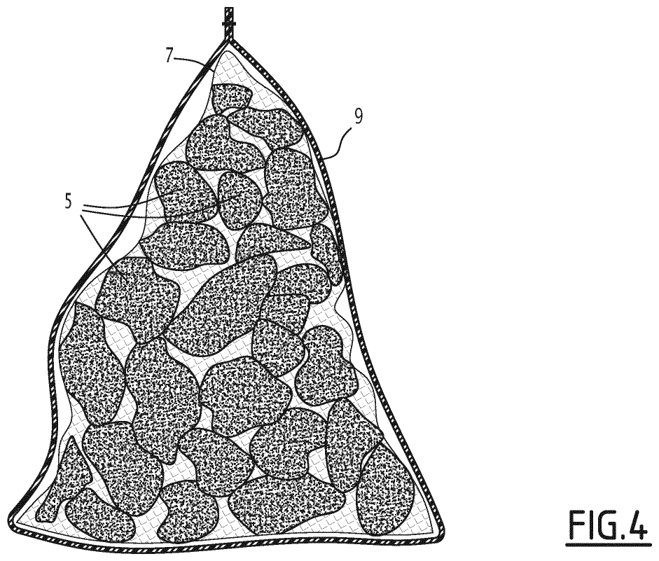

FIG. 4 is a schematic representation of the plant product treatment device according to the invention.

As indicated above, the method of the invention relates to the protection of vegetable products in large quantities, during transportation over long distances and for a significant period of time.

As illustrated in FIG. 1, the process comprises:
placing a mass of vegetable products 1, of between 5 and 50 tons, in a large volume enclosure 3;
transporting said vegetable products in said enclosure 3 for a period of between one week and two months, with a phyto-protective treatment being applied to the vegetable products 1 during said period.

According to the invention, the treatment is applied by placing a quantity of a porous mineral or vegetable material 5 inside the enclosure 3, in which a liquid containing at least one treatment product is absorbed, said treatment product being an essential oil or a constituent of an essential oil.

The porous mineral or vegetable material is arranged inside at least one openwork container 7, allowing circulation of an internal atmosphere of the enclosure 3 through the openwork container 7 in contact with the porous mineral or vegetable material 5.

The enclosure 3 is typically a container or truck, as shown in FIG. 1.

The enclosure 3 is suitable for transporting plant material. For example, the enclosure 3 is refrigerated, so as to maintain the vegetable products at a temperature suitable for their preservation throughout the transportation period .

The enclosure 3 is preferably airtight, so as to limit exchanges between the internal atmosphere of the enclosure and the external atmosphere.

The internal atmosphere of the enclosure 3 is typically air. The composition of the internal atmosphere can evolve over time under the effect of the absorption of certain molecules present in the air by the vegetable products and under the effect of the release of other molecules by the vegetable products.

For example, the composition of the internal atmosphere of the enclosure 3 is regulated, so as to control the concentration of certain elements present in the internal atmosphere (water vapor, CO₂, etc.).

The enclosure 3 has a volume of between 10 and 200 m₃, preferably between 10 and 100 m₃, and even more preferably between 20 and 80 m₃.

The vegetable products transported are chosen from the following list: pomaceous plants such as apples, stone fruits, tropical fruits such as bananas, red fruits such as cherries and strawberries, forest fruits such as blueberries, potatoes, onions, garlic, sweet potatoes, citrus fruits.

The mass of vegetable products to be transported is between 5 and 50 tons, as mentioned above, preferably between 10 and 40 tons and typically between 20 and 30 tons.

The transportation period is between one week and two months, as indicated above, preferably between 15 and 45 days and typically between 20 and 30 days.

The phyto-protective treatment applied during transportation depends on the nature of the vegetable products. It is intended to prevent diseases that may affect the vegetable products during transportation, or to cure these diseases. Disease is understood here to mean any damage that can be caused to vegetable products, regardless of its origin: fungi, insects, etc. The phytosanitary treatment also aims at slowing down the natural evolution of vegetable products. For example, in the case of potatoes, this treatment aims to prevent germination and reduce the attack of fungi.

The treatment is applied for a period long enough to ensure protection. The treatment is typically applied for the duration of the transport. In a variant, it is applied for at least 50% of the transportation time, more preferably at least 80% of the transportation time.

The liquid comprises a single treatment product, or, in a variant, comprises a mixture of several treatment products.

Typically, the liquid comprises only the treatment product(s), without solvent or additive.

In a variant, the liquid comprises an aqueous or organic solvent in which the treatment product(s) and optionally one or more adjuvant(s) are dissolved. The aqueous solvent is water, for example. The organic solvent is a solvent of the type described in FR2791910, for example, or glycols, di-glycols and relative esters thereof. The adjuvants are substances capable of conveying the active ingredient(s), for example, or capable of having a diluting effect.

The essential oil is selected from the group formed by mint oil, clove oil, rose oil, thyme oil, oregano oil, eucalyptus oil, cinnamon oil or peppermint oil for example. The constituent of these oils is selected from the group consisting of L-carvone, eugenol, geraniol, thymol, carvacrol, cinnamaldehyde, eucalyptol, menthol, menthone, limonene, citronellol.

The treatment product is a volatile product. Its boiling point at atmospheric pressure is between 60° C. and 280° C.

The porous mineral or vegetable material is chosen so as to have a liquid absorption capacity of between 5% and 30% by weight, at 20° C. and atmospheric pressure, preferably between 10 and 25% by weight, still more preferably between 10 and 20% by weight.

The liquid absorption capacity is understood here to be per kg of dry porous mineral or vegetable material. In other words, an absorption capacity of 10% by weight means that 1 kg of dry porous mineral or vegetable material is capable of absorbing 100 grams of liquid at 20° C. and atmospheric pressure.

Furthermore, the porous mineral or vegetable material is chosen such that the evaporation rate of the liquid absorbed in said porous mineral or vegetable material is between 10 and 200 grams per day and per kilo of absorbed liquid, ata temperature suitable for the preservation of vegetable products and at atmospheric pressure.

The temperature considered is typically between 0° C. and 9° C.

The temperature suitable for the conservation of tropical fruits and citrus fruits is between 6° C. and 8° C. It is between 4° C. and 9° C. for potatoes. It is about 0° C. for onions, garlic, and sweet potatoes.

Preferably, the evaporation rate is between 20 and 150 grams per day and per kg of absorbed liquid, at a temperature suitable for the preservation of vegetable products and at atmospheric pressure.

The absorption capacity is measured by weighing. The porous mineral or vegetable material is first dried in an oven, for example. It is weighed after drying and before absorption of the liquid. It is then soaked with liquid, by any suitable method, for example by immersion in a liquid bath. The porous mineral or vegetable material is weighed after absorption. The difference between the weight after drying and the weight after absorption gives the absorption capacity.

The evaporation rate is measured by weighing, typically at regular or irregular intervals, for example every day. Specifically, the liquid-laden porous mineral or vegetable material is placed in an enclosure where the temperature and pressure are controlled at the values shown above. The weight of the liquid-filled porous mineral or vegetable material is weighed initially and then at regular or irregular intervals, such as daily. For mineral materials, the weight difference between consecutive weighing corresponds approximately to the amount of liquid evaporated. These weights are used to determine the evaporation rate per day and per kg of liquid absorbed.

The absorption capacity and the rate of evaporation depend, among other things, on the nature of the porous mineral or plant material, the size of the blocks constituting this material, the void rate in the material, the size of the pores of the material.

These different parameters can have any value, provided that the porous mineral or plant material has the desired absorption capacity and evaporation rate.

Typically, the porous mineral or plant material is chosen on the basis of tests to verify that it has the expected properties.

Typically, the porous mineral or vegetable material is chosen from the following list, for example: pumice, pozzolan, clay balls, cellulose, pine bark.

Pumice is a very porous volcanic rock with a low density of less than 1.

All pumice types can be used here, provided they have the expected absorption capacity and evaporation rate.

To that end, the porous mineral or vegetal material is typically in the form of blocks sized between 0.5 and 10 cm, preferably between 0.5 and 5 cm, even more preferably between 0.5 and 3 cm.

Size is understood here as the largest dimension of the block.

If the blocks are too large, they cannot be completely impregnated by the liquid. If the blocks are too small, air circulation between the blocks is limited. The blocks tend to be dustier and can pass through the perforated container too easily.

The fact that the porous mineral or vegetable material is divided into blocks provides a large surface for exchange with the internal atmosphere of the enclosure. Advantageously, the method comprises a step of loading the porous mineral or vegetable material 5 with said liquid.

This step takes place before the transport of the vegetable products.

The loading step includes the following sub-steps:
drying of the porous mineral or vegetable material 5;
impregnation of the liquid in the porous mineral or vegetable material 5.

Drying is carried out by passing air through the porous mineral or vegetable material, or by heating the porous mineral or vegetable material.

Drying increases the amount of liquid stored in the porous mineral or plant material.

On the other hand, if the material is poorly dried, it will release water vapor in addition to the treatment product vapor, which is not necessarily a good thing.

A dry pumice stone holds about 3 times more mint oil than a wet pumice stone.

Impregnation is carried out, for example, by immersing the blocks in a liquid bath, and stirring the blocks to ensure that each block is immersed in the liquid for a sufficient time to allow complete impregnation.

The porous mineral or vegetable material is arranged in one or more openwork containers 7, depending on the mass of porous mineral or vegetable material to be treated.

Typically, the or each openwork container 7 contains between 1 and 20 kg of porous mineral or vegetable material, preferably between 5 and 15 kg, and typically 10 kg.

Having a reasonable amount of porous mineral or vegetable material in a single openwork container 7 makes it easier to bring the internal atmosphere of the enclosure 3 into contact with the porous mineral or vegetable material. If the volume of porous mineral or vegetable material placed inside a single openwork container 7 is too large, the internal atmosphere will have difficulty penetrating to the blocks of porous mineral or vegetable material located in the center of the openwork container.

The porous mineral or vegetable material 5 packed in a single openwork container 7 contains between 0.1 and 6 kg of liquid in total, preferably between 0.5 and 4 kg of liquid in total, even more preferably between 1 and 2 kg of liquid in total.

Openwork is understood here as the fact that the container has a wall with empty, material-free areas, through which the atmosphere can flow between the inside and the outside of the openwork container.

Typically, the or each openwork container 7 has a void ratio per unit area greater than 20%, preferably greater than 30% and even more preferably greater than 50%. By void ratio per unit area is understood here as the ratio of the total area of the void areas of the wall of the openwork container to the total area of the wall of the openwork container.

In other words, the void ratio corresponds to the total surface area of all void areas per 1 m² of wall of openwork container.

The void ratio is typically determined by calculation, considering a unit area of the perforated container. The area occupied by the solid material is determined, using characteristic data of the perforated container or graphically on an image of the perforated container. The empty area is then calculated, by making the difference between the unit area and the area occupied by the solid material. The void ratio is calculated by making the ratio between the void area and the unit area.

The void ratio for an example jute bag is 0.36.

To determine this void ratio, we consider a square of the bag with a side 10 cm. The jute has 40 strands of threads 10 cm wide, and the weaving is at right angles. The square therefore has 80 strands of thread, each 10 cm long and 1 mm thick.

The unit surface SU is here 10×10=100 cm².

The area SP occupied by the solid material, i.e. the woven threads, is calculated as follows:
SP=80×10×0.1−(40×40×0.1×0.1)=64 cm² (total area occupied by the strands minus the area where they overlap).

The empty area SV is equal to 100−64=36 cm².

The void ratio SV/SU is equal to 36/100=0.36.

The or each openwork container is chosen from the following list: jute bag, mesh bag, net, crate.

The amount of porous mineral or vegetable material loaded into the transport enclosure is typically selected as follows.

The input data comprises the transportation duration, and thus the treatment duration, the amount of vegetable products to be transported, the type of mineral or porous vegetable material used, and the type of liquid absorbed into the mineral or porous vegetable material.

This data enables a determination of the surface concentration of the treatment product to be obtained on the surface of the vegetable products in order to make the treatment effective.

This then enables an estimation of the amount of liquid to be evaporated per day in order to keep this concentration substantially constant during the whole journey.

The daily amount to be evaporated is used to determine the amount of porous mineral or vegetable material to be provided inside the transport chamber.

Tests were conducted to evaluate the evaporation rate of different porous materials.

In an initial series of tests, the results of which are shown in FIG. 2, three porous materials were tested: pumice, pozzolan, and clay balls. For each test, a 2 dm³ jute bag was filled completely with the porous material soaked in a total of 100 g of carvone. The dimensions of the filled bag were 6×28×22 cm. The weight of the bag, initially, was 1040 g for the pumice, 2390 g for the pozzolan and 1360 g for the clay balls.

Each bag was kept in a refrigerator, at a temperature of 7.5° C., and weighed daily.

FIG. 2 shows the remaining weight of carvone for each bag (pumice, curve 1, pozzolan, curve 2, clay balls, curve 3).

FIG. 2 shows that the carvone evaporation is regular throughout 14 days, in all three cases. It is almost linear between day 2 and day 10, especially for pumice. The evaporation then reduces between day 10 and day 14.

In a second series of trials, the results of which are shown in FIG. 3, two different quantities of pumice were tested.

The first trial (curve 1) was performed by loading 3.76 kg of pumice soaked with 400 g of carvone in a jute bag.

The second test (curve 2) was performed by loading 10 kg of pumice soaked with 1000 g of carvone into a jute bag.

Each bag was kept in a refrigerator, at a temperature of 7.5° C., and weighed regularly.

FIG. 3 shows the remaining weight of carvone for each bag.

FIG. 3 shows that the carvone evaporation of is regular in both cases,.

For the first test, it is almost linear between day 1 and day 8. The evaporation then progressively reduces between day 8 and day 30.

For the second test, the curve is almost linear between day 1 and day 12. Evaporation then gradually reduces between day 13 and day 30, but remains at a high level.

An example embodiment will now be detailed.

A quantity of potatoes of between 20 and 30 tons is transported over a period of 15 to 20 days, with a mint oil treatment applied during the journey.

The target concentration for the mint oil on the surface of the potatoes is between 70 and 100 ppm. To maintain such a concentration, it is necessary to evaporate about 100 grams of mint oil per day.

The porous mineral or vegetable material used is pumice. In order to achieve the desired evaporation capacity, two 10 kg bags of pumice stone are provided in the transport chamber receiving the potatoes, with 1 kg of mint oil absorbed in each 10 kg batch of pumice stone. The pumice stones are packed in jute bags.

According to an advantageous aspect of the invention illustrated in FIG. 4, to facilitate the preservation of the liquid laden porous mineral or vegetable material before loading into the transport enclosure, the openwork container loaded with liquid-soaked porous mineral or vegetable material is placed in an overpack that is sealed vis-á-vis and airtight vis-á-vis the vapors of each essential oil.

A set is thus constituted, typically comprising:
between 1 and 20 kg of a porous mineral or vegetable material 5;
between 0.1 kg and 6 kg of a liquid absorbed in the porous mineral or vegetable material, the liquid containing at least one treatment product, the treatment product being an essential oil or a constituent of an essential oil, the porous mineral or vegetable material having a liquid absorption capacity of between 5% and 30% by weight at 20° C., the evaporation rate of the liquid absorbed in the porous mineral or vegetable material being between 10 and 200 grams per day and per kg of absorbed liquid at a temperature suitable for the preservation of vegetable products and at atmospheric pressure;
a openwork container 7 inside which the porous mineral or vegetable material is arranged, the openwork container allowing circulation of an atmosphere through the openwork container in contact with the porous mineral or vegetable material
an overpack 9 that is impermeable to the liquid and vapors of the treatment product, in which the openwork container 7 containing the porous mineral or vegetable material 5 is placed.

This set makes it possible, after the liquid has been absorbed by the porous mineral or vegetable material 5 and this has been conditioned in the openwork container 7, to preserve it before loading in the transport enclosure 3.

The sealed overpack 9 is a bag made of high-density polyethylene, polypropylene or aluminum, for example.

The porous mineral or vegetable material and the liquid are as described above. The amounts of porous mineral or vegetable material and liquid per openwork container are as described above.

The openwork container is as described above.

1. A process of vegetable products protection during transportation, the process comprising:
placing a mass of vegetable products of between 5 and 50 tons in a large volume enclosure;
transporting said vegetable products in said enclosure for a period of between one week and two months, a phyto-protective treatment being applied to the vegetable products during at least part of said period;
the treatment being applied by placing a quantity of a porous mineral or vegetable material wherein a liquid containing at least one treatment product is absorbed inside said enclosure, the treatment product being an essential oil or a constituent of an essential oil;
the porous mineral or vegetable material having a liquid absorption capacity of between 5% and 30% by weight at 20° C.;
the evaporation rate of the liquid absorbed in the porous mineral or vegetable material being between 10 and 200 g per day and per kg of absorbed liquid at a temperature suitable for the preservation of the vegetable products and at atmospheric pressure;
the porous mineral or vegetable material being arranged inside at least one openwork container allowing an internal atmosphere of the enclosure to circulate through the openwork container in contact with the porous mineral or vegetable material.

2. The vegetable products protection during transportation process according to claim 1, wherein the enclosure is a container or a truck.

3. The vegetable products protection during transportation process according to claim 1, wherein the vegetable products are selected from the following list: pomaceous plants such as apples, stone fruits, tropical fruits such as bananas, red fruits such as cherries and strawberries, forest fruits such as blueberries, potatoes, onions, garlic, sweet potatoes, citrus.

4. The vegetable products protection during transportation process according to claim 1, wherein the or each treatment product is selected from the following list:
essential oil: mint oil, clove oil, rose oil, thyme oil, oregano oil; eucalyptus oil, cinnamon oil, peppermint oil;
constituent of an essential oil: L-carvone, eugenol, geraniol, thymol, carvacrol, cinnamaldehyde, eucalyptol, menthol, menthone, limonene, citronellol.

5. The vegetable products protection during transportation process according to claim 1, wherein the porous mineral or vegetable material is selected from the following list: pumice, pozzolan, clay balls, cellulose, pine bark.

6. The vegetable products protection during transportation process according to claim 1, wherein the or each openwork container has a void ratio per unit area greater than 20%.

7. The vegetable products protection during transportation process according to claim 1, wherein the or each openwork container is selected from the following list: jute bag, mesh bag, net, crate.

8. The vegetable products protection during transportation process according to claim 1, wherein the or each openwork container contains between 1 and 20 kg of porous mineral or vegetable material.

9. The vegetable products protection during transportation process according to claim 1, wherein the porous mineral or vegetable material is divided into blocks sized between 0.5 and 10 cm.

10. The vegetable products protection during transportation process according to claim 1, wherein the process comprises a step of loading the porous mineral or vegetable material with said liquid, the loading step comprising the following sub-steps:
drying of the porous mineral or vegetable material;
impregnation of the liquid in the porous mineral or vegetable material.

11. A device for treating vegetable products during long-term transport in a large-volume enclosure, the device comprising:
between 1 and 20 kg of a porous mineral or vegetable material;
between 0.1 kg and 6 kg of a liquid absorbed into the porous mineral or vegetable material, the liquid containing at least one treatment product, the treatment product being an essential oil or a constituent of an essential oil
the porous mineral or vegetable material having a liquid absorption capacity of between 5% and 30% by weight at 20° C., the evaporation rate of the liquid absorbed in the porous mineral or vegetable material being between 10 and 200 g per day and per kg of absorbed liquid at a temperature suitable for preserving vegetable products and at atmospheric pressure
an openwork container inside which the porous mineral or vegetable material is arranged, the openwork container allowing the atmosphere to circulate through the openwork container in contact with the porous mineral or vegetable material;
an overpack that is sealed against said liquid and the vapors of the treatment product, in which the openwork container containing the porous mineral or vegetable material is placed.
